(19) United States
(12) Patent Application Publication
(10) Pub. No.: US 2025/0267173 A1
(43) Pub. Date: Aug. 21, 2025

(54) SYSTEMS AND METHODS FOR RISK MANAGEMENT USING MACHINE LEARNING

(71) Applicant: Capital One Services, LLC, McLean, VA (US)

(72) Inventor: Vishi CLINE, Frisco, TX (US)

(73) Assignee: Capital One Services, LLC, McLean, VA (US)

(21) Appl. No.: 19/056,200

(22) Filed: Feb. 18, 2025

Related U.S. Application Data
(60) Provisional application No. 63/555,691, filed on Feb. 20, 2024.

(51) Int. Cl. H04L 9/40

(52) U.S. Cl. CPC H04L 63/20

(57) ABSTRACT

A method may include receiving, from an external entity, information associated with a procedure that includes a control representing a security policy. The method may include transforming the information into transformed information. The method may include determining, using a first machine learning model, a plurality of features including an average reconciliation ratio and an indication of whether the security policy is accurate, based on the transformed information. The method may include determining, using a second machine learning model, a probability that the transformed information does not satisfy a plurality of criteria, based on the plurality of features. The method may include determining whether the probability is greater than a threshold value, and upon determining that the probability is greater than the threshold value, determining, using a third machine learning model, a recommendation to implement one or more actions associated with the control, based on the probability.

### CROSS-REFERENCE TO RELATED APPLICATION(S)

This application claims the benefit of pending U.S. Provisional Patent Application No. 63/555,691, filed on Feb. 20, 2024, which is incorporated herein by reference in its entirety.

### TECHNICAL FIELD

Various embodiments of this disclosure relate generally to techniques for risk management, and more particularly to systems and methods for risk management using machine learning.

### BACKGROUND

Many organizations undergo audits, which are inspections of different aspects of organizations. For example, an organization may undergo a financial audit to verify the accuracy and integrity of the organization's financial documents, an operational audit to evaluate the efficiency and effectiveness of the organization's operations, or a compliance audit to ensure that the organization is in compliance with relevant laws, regulations, industry standards, or policies. In some cases, an organization may be required by law to have an independent external party audit the organization, while in other cases, an organization may audit itself.

Audits can benefit an organization in a number of ways, such as by identifying and mitigating risks, building trust with stakeholders (e.g., regulators, investors, or customers), or identifying areas where the organization's operations can be improved. However, when an organization fails an audit, the consequences can be severe. For example, the organization may be subject to financial penalties or legal action, or the organization's reputation may suffer. However, even if an organization is aware of the consequences that may result from failing an audit, the organization may still fail to adequately prepare for the audit. Moreover, the organization may not be aware of the likelihood that the organization will pass (or fail) the audit.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for risk management using machine learning, are disclosed. Each of the examples disclosed herein may include one or more features described in connection with any of the other disclosed examples.

In one aspect, an exemplary embodiment of a method may include receiving, from an external entity, first information associated with a procedure, where the procedure includes a control representing a security policy. The method may include transforming the first information into first transformed information. The method may include determining, using a first machine learning model, a first plurality of features including a first average reconciliation ratio and a first indication of whether the security policy is accurate, based on the first transformed information, where the first machine learning model was trained using data representing the procedure, a plurality of criteria associated with the control, and historical audit data. The method may include determining, using a second machine learning model, a first probability that the first transformed information does not satisfy the plurality of criteria, based on the first plurality of features, where the second machine learning model was trained using at least the historical audit data. The method may include determining whether the first probability is greater than a threshold value. The method may also include upon determining that the first probability is greater than the threshold value, determining, using a third machine learning model, a recommendation to implement one or more actions associated with the control, based on the first probability, where the third machine learning model was trained using at least the data representing the procedure and the plurality of criteria associated with the control.

In a further aspect, an exemplary embodiment of a system may include at least one processor and at least one memory having programming instructions stored thereon, which, when executed by the at least one processor, cause the system to perform operations. The operations may include receiving, from an external entity, information associated with a procedure, where the procedure includes a control representing a security policy. The operations may include transforming the information into transformed information. The operations may include determining, using a first machine learning model, a plurality of features including an average reconciliation ratio, based on the transformed information, where the first machine learning model was trained using at least data representing the procedure and a plurality of criteria associated with the control. The operations may include determining, using a second machine learning model, a probability that the transformed information does not satisfy the plurality of criteria, based on the plurality of features, where the second machine learning model was trained using at least historical audit data. The operations may include determining, using a third machine learning model, a recommendation to implement one or more actions associated with the control, based on the probability, wherein the third machine learning model was trained using at least the data representing the procedure and the plurality of criteria associated with the control.

In another aspect, an exemplary embodiment of a method may include receiving, from an external entity, information associated with a procedure, where the procedure includes a control representing a security policy. The method may include transforming the information into transformed information. The method may include determining, using a first machine learning model, a plurality of features including an average reconciliation ratio and an indication of whether the security policy is accurate, based on the transformed information, where the first machine learning model was trained using at least data representing the procedure and a plurality of criteria associated with the control. The method may include determining, using a second machine learning model, a probability that the transformed information does not satisfy the plurality of criteria, based on the plurality of features, where the second machine learning model was trained using at least historical audit data. The method may include determining whether the probability is greater than a threshold value. The method may also include, upon determining that the probability is greater than the threshold value, determining, using a third machine learning model, a recommendation to implement one or more actions associated with the control, based on the probability, where the third machine learning model was trained using at least the data representing the procedure and the plurality of criteria associated with the control.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flowchart of an example method, according to one or more embodiments.

FIG. 3 depicts a flow diagram for training a machine learning model, according to one or more embodiments.

FIG. 4 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “user” may refer to a person (e.g., an employee, a manager, a contractor, or the like).

As used herein, the term “entity” may refer to an organization, a business (e.g., a company, a for-profit business, a non-profit business, a vendor, a supplier, etc.), a business unit, a department, a regulatory body, a governmental agency, an industry association, or the like.

As used herein, the term “information” may represent data that is qualitative or quantitative, facts, knowledge, findings, intelligence, news, or the like. In some aspects, information may be electronic (e.g., digital) or physical.

As used herein, the term “sensitive information” may refer to information that is intended for, or restricted to the use of, one or more users or entities. Sensitive information may represent information that is personal, private, confidential, privileged, secret, classified, or in need of protection. Examples of sensitive information may include non-public information (NPI); personally identifiable information (PII) such as a name, address, phone number, social security number, or driver's license number; business information such as trade secrets, proprietary information, or business strategy information; governmental information such as classified or secret information related to national security or defense; medical information such as a patient's medical history, a doctor's summary or diagnosis, or medical test results; academic information such as a student's grades or transcript; data that is copyrighted; financial data such as account numbers, credit card account numbers, checking account numbers, virtual card numbers, savings account numbers, account balances, credit card account balances, checking account balances, savings account balances, financial statements, bills, invoices, or the like.

As used herein, the term Service Level Agreement (“SLA”) may refer to an agreement or contract between a service provider and a client that defines the services to be provided (e.g., tasks to be performed) by the service provider. In some embodiments, an SLA may provide detailed descriptions of the services to be provided, standards (e.g., throughput, response time, uptime, resolution time, or the like) used to measure the services performed, support services to be provided by the service provider (e.g., procedures for escalating issues, helpdesk support, maintenance schedules, or the like), or remedies (e.g., penalties) if the services are not provided in accordance with the standards.

As used herein, the term “risk” (also referred to herein as a “threat”) may refer to a circumstance, scenario, or event that could adversely impact, or that previously adversely impacted, the ability of an entity to achieve its goals. Risks may be legal, operational, reputational, financial, or environmental. For example, risks may include misrepresentation of information (e.g., financial information or metrics); inaccurate, erroneous, or fraudulent information; theft or misuse of assets; inefficient processes that result in delays, increased costs, reduced productivity, bottlenecks in operations, or excessive waste; disruptions in supply chains that impact an organization's ability to deliver products or services; bankruptcy of suppliers; geopolitical issues; failure of an entity to comply with laws, regulations, industry standards, or policies, which may result in penalties, fines, legal action, or reputational damage; unauthorized access to or misuse of information (e.g., a data breach); hacking, cyberattacks, ransomware, or malware that may compromise sensitive information or operations; failure of infrastructure or technology (e.g., software bugs, hardware malfunctions, or network outages); increased competition that impacts profitability or market share; failure to achieve expected synergies, integration issues, or cultural conflicts, resulting from strategic partnerships, mergers, or acquisitions; more stringent laws or regulations resulting in operational impacts, increased costs, fines; disruptions caused by natural disasters such as fires, floods, hurricanes, or earthquakes, etc.

As used herein, the term “control” may refer to a law, regulation, industry standard, policy, practice, procedure, or measure designed (or implemented) to identify or manage (or prevent, block, or mitigate) one or more risks. Put differently, the term “control” may refer to a law, regulation, industry standard, policy, practice, procedure, or measure designed (or implemented) to ensure accuracy, integrity, or compliance of information or an activity (e.g., an operation).

In some aspects, a control may represent an internal control, which is a policy, agreement (e.g., an SLA), contract, guideline(s), practice, procedure (e.g., a standard operating procedure) or measure designed (or implemented) by an entity to achieve the entity's goals. An internal control may be, for example, segregation of duties among different people such as employees or contractors (e.g., to ensure that no one person has control over all aspects of a financial transaction); a protocol for authorization or approval (e.g., of a financial transaction, process, policy, technology, or change to technology); reconciliation (or comparison) of records (e.g., financial records or data) for accuracy, matching, or consistency; access restrictions or security measures (e.g., measures to protect or limit access to sensitive information, physical assets, digital assets, systems, or property such as inventory, cash, or equipment) such as masking, obfuscation, or anonymization of information, password protection, permissions, multi-factor authentication, role-based access controls, firewalls, virtual private networks, audit logs (e.g., logs of what users or entities access at a particular time or date), encryption, locks, cameras, security guards, keycard access systems, or structures or sensors used to protect, manage, or track physical assets or property; documenting policies or procedures and ensuring that employees follow the policies or procedures; maintaining accurate and thorough records of decisions or transactions (e.g., financial transactions); ensuring employees are adequately trained and aware of procedures and policies; conducting performance reviews of employees; measures to ensure patient safety; processes to optimize operations; methods to foster a culture of continuous improvement and transparency; an SLA between an entity's business units or departments; monitoring, reviewing, or auditing operations and transactions (e.g., financial transactions) to identify and reduce inefficiencies, and to identify and resolve issues or discrepancies (e.g., by alerting appropriate personnel or entities, adjusting a procedure after discovering an issue with the procedure), etc.

Further, in some aspects, a control may represent an external control, which is a law, regulation, industry standard, agreement, contract (e.g., an SLA), or guideline(s) imposed by an entity (e.g., a regulatory body, government agency, or industry association) that is external to another entity (e.g., a business). An external control may be, for example, the Sarbanes-Oxley Act (SOX), the General Data Protection Regulation (GDPR); the Generally Accepted Accounting Principles (GAAP); the International Financial Reporting Standards (IFRS); network and telecommunications standards such as IEEE 802.11 and the Optical Transport Network (OTN) Standard (ITU-T G.709); information security standards such as ISO/IEC 27001 and NIST SP 800-53; software and systems standards such as ISO/IEC 12207; quality management standards such as ISO 9001 and LEED (Leadership in Energy and Environment Design); occupational health and safety standards such as ISO 45001; automotive industry standards such as ISO/TS 16949; an SLA between an organization and external service provider or vendor; scrutiny by the public or media; creditworthiness and financial health evaluations; audits; peer reviews, etc.

As used herein, a “machine learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data (e.g., experiential data or samples of input data), which are fed into the model in order to establish, tune, or modify one or more aspects of the model (e.g., the weights, biases, criteria for forming classifications or clusters, or the like). Aspects of a machine learning model may operate on an input linearly, in parallel, via a network (e.g., a neural network), or via any suitable configuration.

The execution of the machine learning model may include deployment of one or more machine learning techniques, such as a neural network(s), convolutional neural network(s), regional convolutional neural network(s), mask regional convolutional neural network(s), deformable detection transformer(s), linear regression, logistical regression, random forest, gradient boosted machine (GBM), deep learning, or a deep neural network. Supervised or unsupervised training may be employed. For example, supervised learning may include providing training data and labels corresponding to the training data as, for example, ground truth. Unsupervised approaches may include clustering, classification, or the like. Any suitable type of training may be used (e.g., stochastic, gradient boosted, random seeded, recursive, epoch or batch-based, etc.). In some embodiments, a machine learning technique (e.g., a machine learning model, methodology, or algorithm) may be selected and executed or deployed based on the volume of data to be processed using the machine learning technique and the computing resources available.

In the following description, embodiments will be described with reference to the accompanying drawings. As will be discussed in more detail below, various embodiments, methods, and systems for risk management using machine learning are described.

In an exemplary use case, a bank may wish to perform an audit of a control (e.g., access restrictions) that has been used in a procedure for securing financial information of customers of the bank. In some embodiments, the audit may represent a rehearsal for a formal audit of the control, where the formal audit is to be performed in the future by a party that is independent from, and external to, the bank. The financial information may be stored in a database with which the access restrictions are associated. Further, the database may be included in a computing device operated by the bank. In some aspects, the computing device may be configured to audit the access restrictions in accordance with an audit plan.

To begin the audit, the computing device may receive, from the database or other source internal or external to the computing device, information associated with the access restrictions and the procedure (e.g., information representing (i) the access restrictions, (ii) the procedure, (iii) data accessed using the access restrictions, or (iv) one or more users who accessed the data, or the like). The computing device may transform (e.g., standardize, normalize, or reformat) the information into transformed information. The computing device may further use a first machine learning model to determine features based on the transformed information. In some embodiments, the features may include, for example, an indication of whether the access restrictions are correct. The computing device may also use a second machine learning model to determine a probability that the transformed information (or the control) will not pass the formal audit, based on the determined features.

In some embodiments, the computing device may compare the probability to a threshold probability (e.g., a threshold value), where the threshold probability may represent the maximum risk that the bank is willing to tolerate with respect to the access restrictions failing the formal audit. In some embodiments, the computing device may determine that the probability is greater than the threshold probability, which may represent that the access restrictions (or control) would likely not pass the formal audit. Further, upon determining that the probability is greater than the threshold probability, the computing device may use a third machine learning model to determine a recommendation to implement one or more actions (or guideline(s)) configured to improve or correct the access restrictions so that the access restrictions will likely pass the formal audit, based on the probability. In some embodiments, the computing device may subsequently notify an employee of the bank regarding outcome of the audit, including the recommendation (e.g., by displaying a notification on a display screen associated with the computing device). In some embodiments, the employee may consider whether and how to implement the recommendation, while in other embodiments, the recommendation may be implemented automatically.

In some embodiments, once the recommendation is implemented to improve (or remediate any issues associated with) the access restrictions, the computing device may audit the improved access restrictions once again to determine whether the improved access restrictions will likely pass the formal audit. In some aspects, the computing device may perform the audit repeatedly (e.g., in an iterative manner), until the access restrictions are likely to pass the formal audit (e.g., where the probability output from the second machine learning model is less than the threshold probability).

Accordingly, the computing device is configured to perform a machine learning-based audit that helps the bank prepare for a formal audit by proactively remediating any issues with a control. Put differently, the audit helps the bank mitigate risks associated with failing the formal audit (e.g., risks such as fines, legal action, reputational damage, or the like). Moreover, the audit may help the bank foster a culture of continuous improvement, transparency, and accountability, by promptly notifying one or more bank employees of the result of the audit, including the recommendation, and by optionally automatically implementing one or more actions specified in the recommendation.

While the example use case described above involves an audit that serves as a rehearsal for a formal audit, in some embodiments, the audit may not serve as such as rehearsal, but rather as a process or tool just for ensuring the integrity and accuracy of the bank's access restrictions. In such embodiments, the probability output by the second machine learning model may represent a score or indication as to whether the access restrictions fail (or pass) the audit performed by the computing device. For example, where the probability output by the second machine learning model falls below the threshold probability, the output probability may represent that the access restrictions pass the audit performed by the computing device.

While the example above involves a control that represents access restrictions, it should be understood that techniques according to this disclosure may be adapted to any suitable type of control (e.g., an internal control or external control). It should also be understood that the example above is illustrative only. The techniques and technologies of this disclosure may be adapted to any suitable activity.

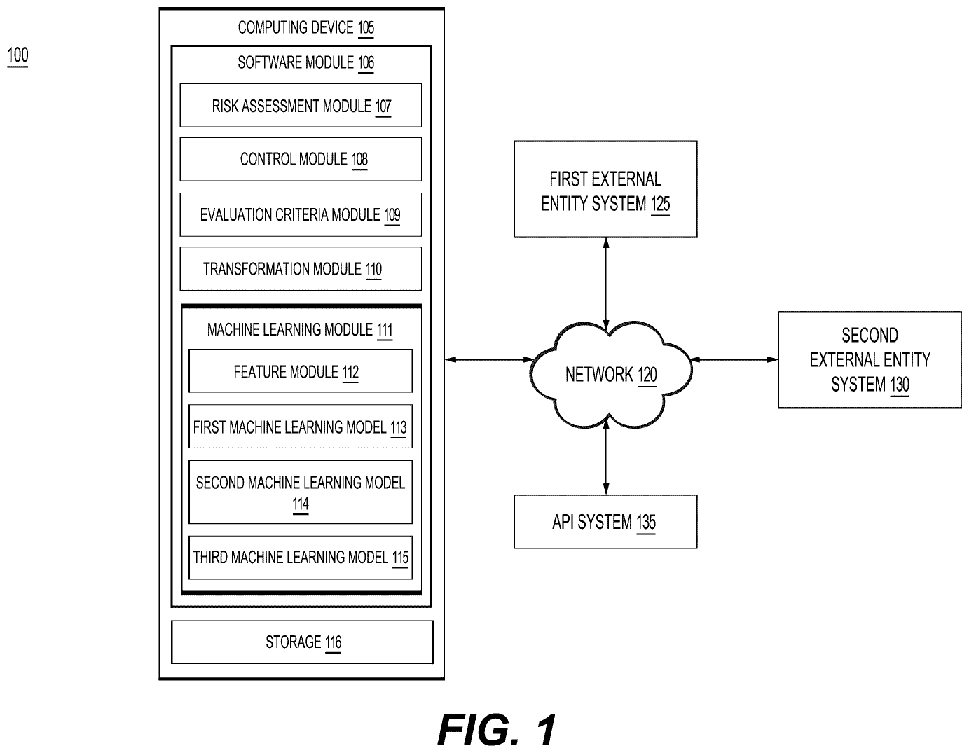

FIG. 1 depicts an example environment 100 that may be utilized with techniques presented herein. As shown in FIG. 1, the environment 100 may include a computing device 105, a network 120 (e.g., an electronic network), a first external entity system 125, a second external entity system 130, and an application programming interface (API) system 135. In some aspects, the computing device 105, the first external entity system 125, the second external entity system 130, and the API system 135 may communicate with one another in any arrangement across the network 120. In some aspects, the computing device 105 may be associated with an entity. Further, in some aspects, the computing device 105 may be associated with a user who is an employee of, or contractor for, the entity.

The computing device 105 may be configured to enable the associated entity (or user) to access or interact with the network 120, the first external entity system 125, the second external entity system 130, or the API system 135, in the environment 100. For example, the computing device 105 may be a computer system such as a server, a desktop computer, a laptop, a workstation, a mobile device, a tablet, etc. In some embodiments, the computing device 105 may include one or more software modules, which may represent electronic application(s) such as a program, a platform, a plugin, or a browser extension, installed on a memory of the computing device 105. For example, as shown in FIG. 1, the computing device 105 may include a software module 106 that includes a risk assessment module 107, a control module 108, an evaluation criteria module 109, a transformation module 110, and a machine learning module 111. In some aspects, the software module 106 may be configured to generate a plan for an audit (also referred to herein as an “audit plan”) and determine either (i) a score (e.g., a percentage or decimal) that indicates whether a control passes or fails the audit, or (ii) a probability that an existing (e.g., implemented) control or a planned control will pass or fail a future audit (e.g., a formal audit) that is similar to the audit defined or described in the audit plan. As used herein, a formal audit (or alternatively referred to as an external audit) may refer to an audit performed by an entity that is independent from, and external to, the entity associated with the computing device 105, and that is similar or identical to an audit defined or described in (or associated with) an audit plan. Further, as used herein, an audit defined or described in (or associated with) an audit plan (or alternatively referred to as an internal audit) may refer to an audit performed, or to be performed, by the entity associated with the computing device 105. In some aspects, an audit plan may represent a digital file or document that defines the scope of an audit conducted, or to be conducted, by the software module 106. The audit plan may specify, for example, how information is to be analyzed, how evidence is to be evaluated, and how information is to be communicated. The computing device 105 may also include a storage 116 (e.g., a memory or storage component). In some embodiments, the storage 116 may be configured store (and subsequently supply or provide) information generated or received by the computing device 105 (e.g., the software module 106). For example, the storage 116 may be configured to store an audit plan, or information that the computing device 105 receives from (i) a user or entity associated with the computing device 105, (ii) the first external entity system 125, (iii) the second external entity system 130, or (iv) the API system 135.

The risk assessment module 107 may be configured to identify, quantify, assess (e.g., evaluate), or prioritize one or more risks (e.g., data representing one or more risks) that may impact, or that previously impacted, the goals or operations of the entity associated with the computing device 105. As explained above, a risk (or threat) may refer to a circumstance, scenario, or event that could adversely impact, or previously adversely impacted, the ability of an entity to achieve its goals. Risks may be legal, operational, reputational, financial, or environmental. For example, risks may include misrepresentation of information (e.g., financial information or metrics); inaccurate, erroneous, or fraudulent information; theft or misuse of assets; inefficient processes that result in delays, increased costs, reduced productivity, bottlenecks in operations, or excessive waste; disruptions in supply chains that impact an organization's ability to deliver products or services; bankruptcy of suppliers; geopolitical issues; failure of an entity to comply with laws, regulations, industry standards, or policies, which may result in penalties, fines, legal action, or reputational damage; unauthorized access to or misuse of information (e.g., a data breach); hacking, cyberattacks, ransomware, or malware that may compromise sensitive information or operations; failure of infrastructure or technology (e.g., software bugs, hardware malfunctions, or network outages); increased competition that impacts profitability or market share; failure to achieve expected synergies, integration issues, or cultural conflicts, resulting from strategic partnerships, mergers, or acquisitions; more stringent laws or regulations resulting in operational impacts, increased costs, or fines; disruptions caused by natural disasters such as fires, floods, hurricanes, or earthquakes, etc. In some aspects, the risk assessment module 107 may be configured to identify risks that stem from (e.g., are caused or triggered by) other risks. Put differently, the risk assessment module 107 may be configured to identify a waterfall effect of risks (e.g., a series of risks where one risk may lead to another risk, such as a hurricane leading to flooding and power outages, which may lead to disruptions in the delivery of goods or services).

In some embodiments, the risk assessment module 107 may be configured to identify, quantify, assess, or prioritize one or more risks based on the goals (e.g., objectives, audits to pass, certifications to obtain, or the like) of the entity associated with the computing device 105, or the environment or industry in which the entity operates. Further, in some embodiments, the risk assessment module 107 may be configured to receive information representing one or more risks, or the goals, environment, or industry of the entity associated with the computing device 105 (e.g., from the entity or the user associated with the computing device 105 or another entity). After identifying one or more risks, the risk assessment module 107 may assess the likelihood (or probability) of each identified risk occurring, and the likely impact (e.g., waterfall effect or ramifications) of each identified risk. The risk assessment module 107 may further identify the risks that are most likely to occur or that are the most relevant or important to one or more objectives of the entity associated with the computing device 105. In some aspects the risk assessment module may be configured to identify, quantify, assess, or prioritize one or more risks automatically, using artificial intelligence (e.g., a machine learning model), or based on receiving input from the user or entity associated with the computing device 105. In some embodiments, the risk assessment module 107 may be configured to include the one or more risks and likely impact(s) of the one or more risks in an audit plan regarding an audit to which the entity associated with the computing device 105 will or may be subject. Further, in some embodiments, the risk assessment module 107 may be configured to transmit the one or more risks, likely impact(s) of the one or more risks, or the audit plan, to the control module 108 or the evaluation criteria module 109.

The control module 108 may be configured to identify or determine one or more controls (e.g., data representing one or more controls) associated with (e.g., previously implemented by, designed for, or relevant to) the entity associated with the computing device 105. As explained above, a control may refer a law, regulation, industry standard, policy, practice, procedure, or measure designed (or implemented) to identify or manage (e.g., prevent, block, or mitigate) one or more risks. Put differently, the term “control” may refer to a law, regulation, industry standard, policy, practice, procedure, or measure designed (or implemented) to ensure accuracy, integrity, or compliance of information or an activity (e.g., an operation).

In some aspects, a control may represent an internal control, which is a policy, agreement (e.g., an SLA), contract, guideline(s), practice, procedure (e.g., a standard operating procedure) or measure designed (or implemented) by an entity (e.g., the entity associated with the computing device 105) to achieve the entity's goals. An internal control may be, for example, segregation of duties among different people such as employees or contractors (e.g., to ensure that no one person has control over all aspects of a financial transaction); a protocol for authorization or approval (e.g., of a financial transaction, process, policy, technology, or change to technology); reconciliation (or comparison) of records (e.g., financial records or data) for accuracy, matching, or consistency; access restrictions or security measures (e.g., measures to protect or limit access to sensitive information, physical assets, digital assets, systems, or property such as inventory, cash, or equipment) such as masking, obfuscation, or anonymization of information, password protection, permissions, multi-factor authentication, role-based access controls, firewalls, virtual private networks, audit logs (e.g., logs of what users or entities access at a particular time or date), encryption, locks, cameras, security guards, keycard access systems, structures or sensors used to protect, manage, or track physical assets or property; documenting policies or procedures and ensuring that employees follow the policies or procedures; maintaining accurate and thorough records of decisions or transactions (e.g., financial transactions); ensuring employees are adequately trained and aware of procedures and policies; conducting performance reviews of employees; measures to ensure patient safety; processes to optimize operations; methods to foster a culture of continuous improvement and transparency; an SLA between an entity's business units or departments; monitoring, reviewing, or auditing operations and transactions (e.g., financial transactions) to identify and reduce inefficiencies, and to identify and resolve issues or discrepancies (e.g., by alerting appropriate personnel, adjusting a procedure after discovering an issue with the procedure), etc.

Further, in some aspects, a control may represent an external control, which is a law, regulation, industry standard, agreement, contract (e.g., an SLA), or guideline(s) imposed by an entity (e.g., a regulatory body, government agency, or industry association) that is external to (or independent from) another entity (e.g., a business). An external control may be, for example, the Sarbanes-Oxley Act (SOX), the General Data Protection Regulation (GDPR); the Generally Accepted Accounting Principles (GAAP); the International Financial Reporting Standards (IFRS); network and telecommunications standards such as IEEE 802.11 and the Optical Transport Network (OTN) Standard (ITU-T G.709); information security standards such as ISO/IEC 27001 and NIST SP 800-53; software and systems standards such as ISO/IEC 12207; quality management standards such as ISO 9001 and LEED (Leadership in Energy and Environment Design); occupational health and safety standards such as ISO 45001; automotive industry standards such as ISO/TS 16949; an SLA between an organization and external service provider or vendor; scrutiny by the public or media; creditworthiness and financial health evaluations; audits; or peer reviews, etc.

In some aspects, the control module 108 may be configured to receive one or more risks, impact(s) of the one or more risks, or an audit plan, from the risk assessment module 107. In some embodiments, the control module 108 may be configured to identify or determine one or more controls based on the received one or more risks, impact(s) of the one or more risks, or the audit plan, automatically or using artificial intelligence (e.g., a machine learning model). For example, where the entity associated with the computing device 105 represents a bank, and where the control module 108 receives, from the risk assessment module 107, information representing a risk of sensitive information (e.g., a checking account number) being shared with unauthorized personnel at the bank, the control module 108 may automatically determine that a control representing access restrictions would mitigate or prevent the risk. In some embodiments, the control module 108 may be configured to receive one or more controls from the user or the entity associated with the computing device 105. Further, in some embodiments, the control module 108 may be configured to include one or more controls in the audit plan, and transmit the one or more controls or audit plan, to the evaluation criteria module 109.

The evaluation criteria module 109 may be configured to identify or determine one or more criteria used to assess (e.g., evaluate) the accuracy, integrity, effectiveness, efficiency, or compliance of one or more controls or information associated with one or more controls (e.g., information related to, inputted to, processed by, or output from, one or more controls). Put differently, the evaluation criteria module 109 may be configured to identify or determine one or more criteria used to audit an aspect of the entity associated with the computing device 105. As used herein, the term “criteria” may refer to information representing requirements, standards, tests, conditions, measures, benchmarks, guidelines, or the like. In some aspects, the evaluation criteria module 109 may be configured to receive one or more risks, or impact(s) of one or more risks, or an audit plan, from the risk assessment module 107 or the user or entity associated with the computing device 105. The evaluation criteria module 109 may also be configured to receive one or more controls, or an audit plan, from the control module 108 or the user or entity associated with the computing device 105. Further, the evaluation criteria module 109 may be configured to determine one or more criteria based on the received risk(s), impact(s) of risk(s), control(s), or audit plan, automatically or using a machine learning model. The evaluation criteria module 109 may also be configured to receive one or more criteria from the user or entity associated with the computing device 105. In some embodiments, the evaluation criteria module 109 may be configured to identify or determine one or more criteria based historical audit information. As used herein, the term “historical audit information” may refer to information representing or associated with one or more controls subject to one or more previous audits, risk(s) associated with the one or more controls, one or more criteria associated with the one or more controls, and information representing the outcome(s) of the one or more previous audit(s) (e.g., whether the control(s) passed the audit(s) based on the one or more criteria). Further, in some embodiments, the evaluation criteria module 109 may be configured to include one or more criteria in an audit plan. The evaluation criteria module 109 may also be configured to transmit one or more criteria or the audit plan to the machine learning module 111 or the storage 116.

In some embodiments, the one or more criteria identified, determined, or received by the evaluation criteria module 109 may specify tools or techniques to be used to apply the one or more criteria to one or more controls (e.g., to determine whether, or the degree to which, the one or more criteria are satisfied or met). For example, a criterion may specify that in order for a control (or information associated with the control) to be assessed as accurate, effective, efficient, or compliant, (i) evidence or information associated with the control must be collected from one or more specified sources, (ii) a threshold amount of evidence or information, or a threshold number of samples, associated with the control must be gathered (e.g., from one or more specified sources), (iii) certain documents, records, files, or information must be reconciled (e.g., compared for consistency or accuracy) a specified number of times, or at particular stages of a process (e.g., that represents or is associated with the control), (iv) a particular number of items (or a type of item) within one or more documents, records, or files must be counted, (v) one or more interviews with personnel must be conducted, (vi) one or more metrics (e.g., percentages, ratios, error rates, maximum error rates) must be calculated, (vii) one or more tests or examinations must be conducted, (viii) one or more measurements must be taken, (ix) the control (or information associated with the control) must be reviewed or monitored, or the like. In some embodiments, a criterion may specify a value, attribute, or indication that is numerical or qualitative. Further, in some embodiments, a criterion may specify a value, attribute, or indication that is associated with a range or spectrum, or that is binary. In some embodiments, a criterion may include or be associated with a law, regulation, industry standard, policy, practice, procedure, or measure (e.g., with which a control must comply).

The transformation module 110 may be configured to transform (e.g., process or convert) information associated with one or more controls (e.g., information representing, related to, inputted to, processed by, or resulting from, one or more controls) or a procedure including one or more controls. In some aspects, the transformation module 110 may receive or gather the information from one or more sources such as the storage 116, sources internal to or associated with the computing device 105 or the entity associated with the computing device 105, vendor products, the first external entity system 125, the second external entity system 130, or the API system 135. In some embodiments, the transformation module 110 may be configured to transform information in accordance with one or more criteria of the evaluation criteria module 109 or an audit plan. In some aspects, the transformation module 110 may be configured to aggregate (e.g., integrate, combine, centralize, or merge), summarize, categorize, or group information received from one or more sources. Further, the transformation module 110 may be configured to reformat (e.g., modify the file-type or units of), standardize, or normalize (e.g., scale) information received from one or more sources. In some embodiments, the transformation module 110 may be configured to detect or remove any errors, duplicates, or irrelevant information from the information received from one or more sources. In some aspects, the transformation module 110 may be configured to pre-process or format information received from one or more sources for input to the machine learning module 111.

As shown in FIG. 1, the machine learning module 111 may include a feature module 112, a first machine learning model 113, a second machine learning model 114, and a third machine learning model 115. The feature module 112 may be configured to identify, determine, or receive one or more features (e.g., quantitative values or qualitative indications or characteristics) that may be used to (i) predict the probability of one or more controls (or information associated with one or more controls) passing or failing a formal audit that is similar to an audit defined in an audit plan (e.g., received from the evaluation criteria module 109), or (ii) determine a score (e.g., a percentage or decimal) that represents whether the one or more controls pass or fail an audit defined in an audit plan. As used herein, the term “score” may also be referred to as a probability. In some embodiments, the feature module 112 may identify or determine one or more features that represent one or more criteria received from the evaluation criteria module 109. Further, in some embodiments, the feature module 112 may receive one or more features from the user or entity associated with the computing device 105. In some embodiments, the feature module 112 may be configured to determine one or more features based on historical audit information (where the historical audit information may or may not involve the entity associated with the computing device 105). In some embodiments, the feature module 112 may be configured to determine one or more features based on information that is received in real time or near real time (or that is dynamically received) from one or more sources (e.g., the computing device 105, the entity associated with the computing device 105, the first external entity system 125, the second external entity system 130, or the API system 135). In such embodiments, the one or more features may be generated in real time or near real time by the one or more sources. Further, in some embodiments, the feature module 112 may use a machine learning model (e.g., trained using historical audit data) to determine one or more features.

In some aspects, a feature identified, determined, or received by the feature module 112 may be an average reconciliation ratio. An average reconciliation ratio may represent a total number of items reconciled during a time period, divided by a total number of items that should have been reconciled during the time period. As used herein, the term “items” may refer to financial transactions, particular pieces of information, or the like. In some aspects, a higher average reconciliation ratio may indicate a more accurate or more thorough reconciliation process, while a lower average reconciliation ratio may indicate a less accurate or less thorough reconciliation process. In some embodiments, a feature identified, determined, or received by the feature module 112 may represent a determination as to whether a control, or information associated with a control, includes sensitive information (e.g., NPI or PII). Further, a feature identified, determined, or received by the feature module 112 may represent a determination as to whether a control that represents a policy is accurate. For example, where a control represents a security policy that identifies what users are authorized to access particular information or a particular system, a feature identified, determined, or received by the feature module 112 may represent a determination as to whether the control representing the security policy is correct (or identifies the correct users). In some aspects, the feature module 112 may be configured to combine one or more features to generate one or more new features configured to help predict whether one or more controls may pass or fail an audit. In some embodiments, the feature module 112 may be configured to provide one or more features as input to the first machine learning model 113.

The first machine learning model 113 may be configured to receive, as input(s), transformed information (e.g., representing or associated with one or more controls) from the transformation module 110. The first machine learning model 113 may also be configured to output one or more numerical values or qualitative indications that represent feature(s), based on the input(s). For example, based on the input(s), the first machine learning model 113 may be configured to output a numerical value representing an average reconciliation ratio (e.g., a feature of the feature module 112). In some embodiments, the first machine learning model may be trained using one or more of feature(s) of the feature module 112, data representing a procedure associated with (e.g., including) one or more controls, one or more criteria from the evaluation criteria module 109, an audit plan, or historical audit data.

The second machine learning model 114 may be configured to receive, as input(s), one or more outputs from the first machine learning model 113 (e.g., one or more numerical values or qualitative indications that represent feature(s)), and to output one or more probabilities (or scores) based on the input(s). In some aspects, each of the one or more probabilities may represent a likelihood that a respective control implemented (or to be implemented) will pass or fail a formal audit that is similar to an audit defined in an audit plan. In some other aspects, each of the one or more scores may represent a score that reflects whether a respective control implemented (or to be implemented) passes or fails an audit defined in an audit plan. For example, the second machine learning model 114 may be configured to output a probability (e.g., represented as a percentage or decimal) that a particular control currently being implemented will pass or fail a formal audit, based on one or more outputs from the first machine learning model 113. As another example, the second machine learning model 114 may be configured to output a score (e.g., represented as a percentage or decimal) that reflects whether a particular control fails or passes an audit defined in an audit plan, based on one or more outputs from the first machine learning model 113. In some aspects, where each of a probability of a control failing a formal audit and a probability of the control passing the formal audit are represented by a respective percentage, the sum of the probability of the control failing a the formal audit and the probability of the control passing the formal audit may equal 100%. In some embodiments, the second machine learning model 114 may be trained using one or more of output(s) of the feature module 112, data representing a procedure associated with (e.g., including) one or more controls, one or more criteria from the evaluation criteria module 109, an audit plan, or historical audit data.

In some embodiments, where the second machine learning model 114 outputs a probability (corresponding to a respective control) greater than zero that the respective control will likely fail a formal audit (or a score representing that the respective control fails an audit defined in an audit plan), the probability (or score) may be input to the third machine learning model 115, which may be configured to output a recommendation based on the inputted probability (or score). The recommendation may include one or more indications regarding how the respective control should be modified (e.g., improved, corrected, or remediated) in order to likely pass a formal audit (or pass an audit defined in an audit plan). For example, where the second machine learning model 114 outputs a probability representing that there is a 55% chance a control representing a process for securing digital information will fail a formal audit, the probability may be inputted to the third machine learning model 115, which may output a recommendation that the control be enhanced by encrypting the digital information or by requiring that users who are authorized to access the digital information be subject to multi-factor authentication prior to accessing the digital information. In some embodiments, the machine learning module 111 may configured to associate the recommendation with an audit plan, or include the recommendation in an audit plan. Further, in some embodiments, the third machine learning model 115 may be configured to transmit the recommendation to the storage 116 for storage, or transmit the recommendation to one or more users (e.g., employees) or computing devices of the entity associated with the computing device 105 so that the one or more users or computing devices can consider or implement the recommendation. In some embodiments, the third machine learning model 115 may be configured to transmit the recommendation to the first external entity system 125, the second external entity system 130, or the API system 135 for consideration or implementation (e.g., in real time or near real time). Further, in some embodiments, where the recommendation is implemented (e.g., in real time or near real time), the software module 106 may repeat the auditing process described above to reassess whether an improved (remediated) control will likely pass a formal audit (or pass an audit defined in an audit plan). However, in some embodiments, and regardless of whether the machine learning module 111 generates a recommendation, the software module 106 may repeat the auditing process described above periodically or at a certain frequency (e.g., hourly, daily, monthly, yearly, etc.).

In some aspects, the third machine learning model 115 may be trained using historical audit data or other historical data regarding recommendations implemented to improve the accuracy, effectiveness, efficiency, or compliance of one or more controls, where the improved one or more controls prevented (e.g., blocked) or mitigated associated risks and subsequently passed one or more audits. Further, in some embodiments, the third machine learning model 115 may be trained using one or more of information representing a procedure associated with (e.g., including) one or more controls, one or more criteria from the evaluation criteria module 109, an audit plan, the input(s) or output(s) of the first machine learning model 113, or the input(s) of the second machine learning model 114 (as described above).

In some embodiments, where the second machine learning model 114 outputs a probability that a respective control will fail a formal audit, the probability may be compared to a threshold value and inputted to the third machine learning model 115 based on the comparison. For example, where the second machine learning model 114 outputs a probability representing a 25% chance that a respective control will fail a formal audit, the probability may be compared to a threshold value (or percentage) of 20%, and where the probability is greater than (or greater than or equal to) the threshold value of 20%, the probability may be inputted to the third machine learning model 115. As another example, where the second machine learning model 114 outputs a probability representing an 85% chance that a respective control will pass a formal audit, the probability may be compared to a threshold value (or percentage) of 95%, and where the probability is less than (or less than or equal to) the threshold value of 95%, the probability may be inputted to the third machine learning model 115. In each of the foregoing examples, the threshold value may represent a threshold risk the entity associated with the computing device 105 is (or is not) willing to tolerate with respect to a control failing or passing an audit. It is noted that the threshold values of 20% and 95% are merely examples, and that the threshold value may a different percentage or decimal during actual implementations.

Further, in some embodiments, where the second machine learning model 114 outputs multiple probabilities, and where each of the multiple probabilities represents a likelihood greater than zero that a respective control will fail a formal audit, each of the multiple probabilities may be inputted to the third machine learning model 115, which may be configured to output multiple recommendations, where each of the multiple recommendations is based on a respective one of the multiple probabilities. In some embodiments, the third machine learning model 115 may be configured to transmit the multiple recommendations to (i) the storage 116 for storage, or (ii) one or more users (e.g., employees) or computing devices of the entity associated with the computing device 105 so that the one or more users or computing devices can consider or implement the multiple recommendations. In some embodiments, the third machine learning model 115 may be configured to transmit the multiple recommendations to the first external entity system 125, the second external entity system 13-0, or the API system 135 for consideration or implementation (e.g., in real time or near real time). Further, in some embodiments, where one or more of the multiple recommendations are implemented (e.g., in real time or near real time), the software module 106 may repeat the auditing process described above to reassess whether the improved one or more controls will likely pass the formal audit.

The first external entity system 125 may include a server system or other computing device associated with an entity (e.g., an entity different than or the same as the entity associated with the computing device 105). In some embodiments, the first external entity system 125 may be associated with (e.g., owned or operated by) a business that is a service provider, supplier, partner, or customer of the entity associated with the computing device 105. In some embodiments, the entity associated with the first external entity system 125 may be, for example, (i) a company that provides cloud-based services or customer relationship management (CRM) software (e.g., Salesforce), (ii) a company that provides tools for monitoring and analyzing metrics, logs, and traces (e.g., Datadog), (iii) a company that provides a platform for searching, monitoring, analyzing, and visualizing machine-generated data (e.g., Splunk), (iv) a company that provides cloud-based storage and analytics (e.g., Snowflake), (v) a company such as Amazon Web Services that provides a cloud computing platform that includes or supports infrastructure, serverless compute services (e.g., Lambda) and storage (e.g., S3 or Amazon Simple Storage Service), or (v) a company that provides an event streaming platform, Kafka topics, or tools for log aggregation, event sourcing, or real-time analytics (e.g., Apache Kafka). In some aspects, the first external entity system 125 may be configured to transmit (or supply) information that represents one or more controls or is associated with (e.g., related to, inputted to, processed by, or output from) one or more controls (e.g., a procedure including one or more controls), to the computing device 105, where the information may be audited in accordance with an audit plan using the software module 106. The first external entity system 125 may transmit the information using one or more formats, such as JavaScript Object Notation (JSON), extensible Markup Language (XML), or Comma-Separated values (CSV), Protobuf, Avro, or Thrift.

The second external entity system 130 may include a server system or other computing device associated with an entity (e.g., an entity different than or the same as the entity associated with the computing device 105 or the entity associated with the first external entity system 125). In some aspects, the second external entity system 130 may be an embodiment of the first external entity system 125.

The API system 135 may include a server or other computing device, and may be configured to interact with other systems, such as the computing device 105, the first external entity system 125, or the second external entity system 130, in the environment 100. The API system 135 may be configured to receive and respond to a request for information (from the computing device 105, the first external entity system 125, or the second external entity system 130), or the like. Further, the API system 135 may be configured to transmit and receive information using one or more formats, as JavaScript Object Notation (JSON), extensible Markup Language (XML), or Comma-Separated values (CSV), Protobuf, Avro, or Thrift.

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”).

Although depicted as separate components in FIG. 1, it should be understood that a component or portion of a component in the environment 100 may, in some embodiments, be integrated with or incorporated into one or more other components. For example, in some embodiments, at least a portion of the first external entity system 125, the second external entity system 130, or the API system 135 may be integrated into the computing device. In some embodiments, operations or aspects of one or more of the components discussed above may be distributed amongst one or more other components. Any suitable arrangement or integration of the various systems and devices of the environment 100 may be used. Further, in some embodiments, the environment 100 may include only one external entity system (e.g., the first external entity system 125), more than two external entity systems, or more than one API system.

In an example use case, the entity associated with the computing device 105 may be a bank. The bank may wish to implement a new technology in the bank's web portal, where the new technology is configured to help the bank's clients update their contact information and to secure the updated contact information. The new technology may still be in development by a software engineering company that operates the first external entity system 125. The bank may use the risk assessment module 107 of the computing device 105 to identify, quantity, assess, or prioritize one or more risks that may impact the bank's goal of implementing the new technology. The risk assessment module 107 may determine that key risks associated with the bank's goal include (1) not designing the new technology in a manner that effectively secures clients' updated contact information during storage or transfer (also referred to herein as “key risk 1”), and (2) insufficiently testing the new technology such that when the new technology is deployed, the new technology includes software bugs that prevent clients from updating their contact information (also referred to herein as “key risk 2”). The risk assessment may include key risks 1 and 2 in an audit plan, and transmit the audit plan to the control module 108.

The control module 108 may then receive the audit plan from the risk assessment module 107, analyze the audit plan, and generate (or design) one or more controls to prevent or mitigate key risks 1 and 2. For example, the control module 108 may determine a first control that includes incorporating a form of encryption in the new technology and obfuscating updated contact information that is stored or transferred using the new technology, in order to prevent or mitigate key risk 1. The control module 108 may also determine a second control that includes testing the new technology using at least 10,000 samples of fictitious contact information and verifying that the 10,000 samples are correctly transferred and stored by the new technology, in order to prevent or mitigate key risk 2. In some embodiments, the control module 108 may generate digital representations of the first and second controls and transmit the digital representations to the software engineering firm (e.g., the first external entity system 125) so that the software engineering firm can finish designing and testing the new technology based on the first and second controls. The control module 108 may also include the digital representations of the first and second controls in the audit plan, and then transmit the audit plan to the evaluation criteria module 109.

The evaluation criteria module 109 may receive the audit plan, and determine criteria to evaluate the effectiveness of the first and second controls based on the audit plan and, for example, historical audit data (e.g., data representing criteria used in previous audits associated with the bank or other entities). For example, the evaluation criteria module 109 may determine that a specified number of samples (e.g., X samples) of information related to the new technology must be gathered, reformatted, and assessed in order to determine the likelihood that the first and second controls would fail a formal audit that is similar to an audit defined in the audit plan. In some embodiments, the evaluation criteria module 109 may include the determined criteria in the audit plan, and then transmit the audit plan to the transformation module 110 and the machine learning module 111. The evaluation criteria module 109 may also optionally transmit the determined criteria or the audit plan to the software engineering firm (e.g., the first external entity system 125).

Once the software engineering company deploys the new technology (e.g., on behalf of the bank) using the first external entity system 125, the software engineering company (e.g., the first external entity system 125) may transmit X samples of information related to the new technology (e.g., as JSON data) to the transformation module 110. Alternatively, the computing device 105 (e.g., the transformation module 110) may retrieve X samples of information related to the new technology from the software engineering firm (e.g., the first external entity system 125).

The transformation module 110 may subsequently reformat the X samples of information related to the new technology for input to the machine learning module 111, in accordance with the audit plan. The transformation module 110 may further transmit the reformatted X samples of information to the machine learning module 111.

The feature module 112 of the machine learning module 111 may receive the reformatted X samples of information from the transformation module 110 (and optionally the audit plan from the evaluation criteria module 109), and determine one or more features that may be used to predict the likelihood that the first and second controls, as implemented, would fail a formal audit that is identical or similar to the audit defined in the audit plan. The feature module 112 may subsequently transmit the determined one or more features (and optionally the audit plan) to the first machine learning model 113, which may receive the determined one or more features (and optionally the audit plan) as inputs or be trained using the determined one or more features (and optionally the audit plan). The first machine learning model 113 may further receive the reformatted X samples of information and generate quantitative output(s) that correspond to (or represent) the determined one or more features, based on the reformatted X samples of information. The output(s) of the first machine learning model 113 may subsequently be input to the second machine learning model 114, which may output one or more probabilities based on the input. For example, the second machine learning model 114 may output a first probability that represents a 25% chance the first control (incorporation of the form of encryption in the new technology and obfuscation of updated contact information that is stored or transferred using the new technology), would fail the formal audit. The second machine learning model 114 may also output a second probability that represents a 22% the second control (testing of the new technology using at least 10,000 samples of fictitious contact information and verification that the 10,000 samples were correctly transferred and stored by the new technology) would fail the formal audit.

In some embodiments, each of the first and second probabilities may be compared to a threshold percentage of 10% (e.g., the maximum likelihood of failing the formal audit that is tolerated by the bank). Because each of the first and second probabilities is greater than the threshold percentage of 10%, each of the first and second probabilities may be input to the third machine learning model 115. In some embodiments, the third machine learning model 115 may be trained using one or more of the reformatted X samples of information, the output(s) of the first machine learning model, or historical audit data. The third machine learning model 115 may output a first recommendation based on the first probability, where the first recommendation indicates that the first control should be modified such that a stronger form of encryption is incorporated in the new technology. The third machine learning model 115 may also output a second recommendation based on the second probability, where the second recommendation indicates that that the second control should be modified to require testing the new technology using at least 15,000 samples of fictitious contact information and verifying that the 15,000 samples are correctly transferred and stored by the new technology.

In some embodiments, the third machine learning model 115 may subsequently transmit the first and second recommendations to (i) the storage 116 for storage, (ii) one or more employees of the bank, and (iii) the software engineering firm (e.g., the first external entity system 125). The software engineering firm (e.g., the first external entity system 125) may subsequently modify the first and second controls as indicated in the first and second recommendations, respectively. The new technology may subsequently be re-deployed based on the modified first and second controls, and the software engineering firm (e.g., the first external entity system 125) may transmit X samples of information related to the re-deployed new technology to the software module 106 for auditing once again. During such auditing, if the second machine learning model 114 outputs updated first and second probabilities that are each equal to or under the 10% threshold, the auditing may be completed and the modified first and second controls may be deemed by the software module 106 (or the bank) to not likely fail the formal audit (or to likely pass the formal audit). However, if the second machine learning model 114 outputs updated first and second probabilities that are over the 10% threshold, the third machine learning model 115 may output updated first and second recommendations to improve the modified first and second controls and to increase the chance that such controls will subsequently be deemed by the software module to not likely fail the formal audit (or to likely pass the formal audit). This auditing may repeat periodically, or until a desired outcome is achieved (e.g., versions of the first and second controls of the new technology are deemed to likely pass the formal audit). Accordingly, the auditing allows the bank and the software engineering firm to derive insights regarding the first and second controls (e.g., insights regarding the efficiency and effectiveness of the first and second controls), while fostering accountability, promoting stronger design of controls, and managing the delivery and refinement of the new technology.

In an example use case, the entity associated with the computing device 105 may be a lender. The lender may wish to access a credit report (e.g., an electronic credit report that is current) of one of the lender's customers on a monthly basis for one year, where each of the monthly credit reports would be generated by a credit bureau associated with the first external entity system 125. The lender and the credit bureau may be parties to an SLA that stipulates how the credit bureau is to generate and make each of the monthly credit reports (associated with the customer) accessible to the lender. The SLA may specify that, once the SLA is fully executed by both the lender and the credit bureau, the first external entity system 125 is to immediately begin preparing the first credit report of the monthly credit reports. The SLA may further specify that to prepare the first credit report, the first external entity system 125 is to retrieve, from a database included in the first external entity system 125, financial data that is specific to the customer, and generate the first credit report based on the retrieved financial data (e.g., by transforming the retrieved financial data into the first credit report). The SLA may further specify that once the first credit report is generated, the first external entity system 125 is to mask (or obfuscate) the content of the first credit report, and then transmit the first credit report including the masked content to a database (e.g., a cloud storage) associated with (e.g., included in) the second external entity system 130. The SLA may specify that once the database of the second external entity system 130 receives the first credit report including the masked content, the second external entity system 130 is to immediately send an alert to the computing device 105, where the alert serves to notify the lender that the first of the monthly credit reports is now accessible to the lender (or that the lender may now retrieve the first credit report from the database of the second external entity system 130). The SLA may further specify that when the lender accesses the first credit report via the database of the second external entity system 130, the content of the credit report will not appear masked to the lender. The SLA may specify that each of the remaining monthly credit reports is to be generated and made accessible to the lender in a similar manner as that described above.

The SLA may further specify various controls to be implemented by the credit bureau and an entity associated with the second external entity system 130 to ensure that the aforementioned services specified in the SLA are properly performed. The controls may include electronically (or manually) (i) verifying that each of the monthly credit reports includes content that is current, accurate, and masked, (ii) verifying that the content of each of the monthly credit reports includes standard information regarding the customer (e.g., information traditionally included in a credit report or information that the lender needs to know), (iii) verifying that each of the monthly credit reports is made accessible to the lender in a timely manner (e.g., at the same time each month for one year), (iv) verifying that the database of the second external entity system 130 is governed by a policy that restricts access to each of the monthly credit reports to the lender only, (v) verifying that only each of the monthly credit reports is made accessible to the lender in the database of the second external entity system 130, (vi) verifying that the number of credit reports generated by the first external entity system 125 (e.g., 12) equals the number of credit reports stored in the second external entity system 130 (e.g., 12) and the number of credit reports accessed by the lender over a year (e.g., 12) (or reconciling counts at various stages of the process), (vii) verifying that each of the 12 alerts is actually sent to the computing device 105 (e.g., the lender) and optionally acknowledged by the lender, (viii) verifying that each of the 12 alerts is sent to the computing device 105 in a timely manner, and (ix) ensure that any issues or problems identified with respect to generating and making accessible the monthly credit reports are resolved within one week.

The SLA, including the controls specified in the SLA, may be included in an audit plan of the software module 106. The evaluation criteria module 109 may determine criteria to evaluate the controls during an audit associated with the audit plan. Once the credit bureau begins to generate the monthly credit reports, or after one or more of the monthly credits reports is generated and made accessible to the lender, the software module 106 may perform an audit in accordance with the audit plan to assess the controls specified in the SLA and, if necessary, provide recommendations to the lender, credit bureau, and optionally the entity associated with the second external entity system 130, for improving the controls. Accordingly, the audit may serve to verify the integrity of the services provided by the credit bureau and the entity associated with the second external entity system 130. As a result, the lender can be confident that the requested credit reports are accurate and made available in a timely manner, and in turn the lender may be able to make informed decisions about whether to periodically grant loans to the customer based on the monthly credit reports.

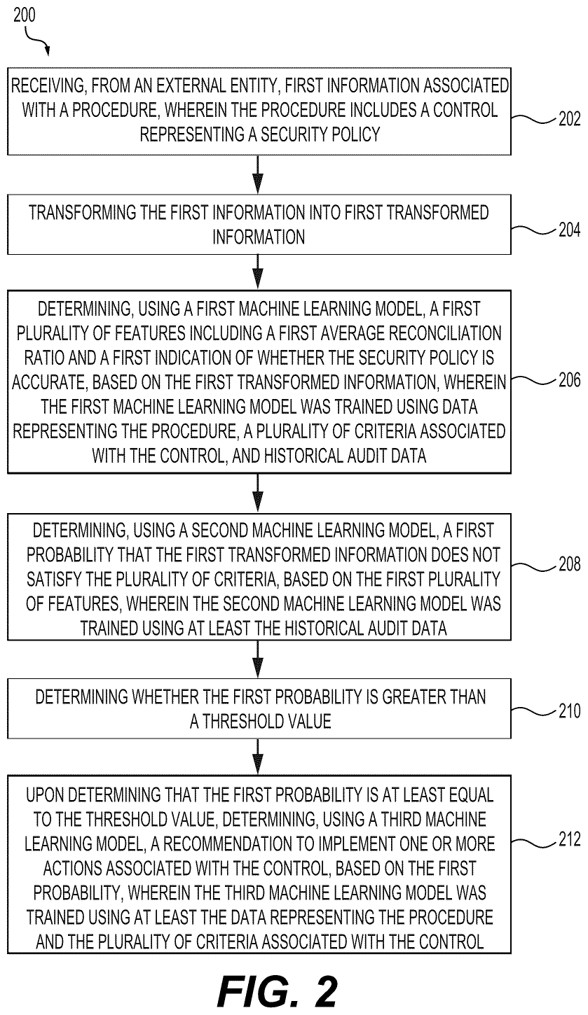

FIG. 2 is a flowchart illustrating a method 200 for auditing a control using machine learning, according to one or more embodiments of the present disclosure. In some aspects, the method 200 may be performed by the computing device 105.

As shown in FIG. 2, the method 200 may include receiving, from an external entity (e.g., the first external entity system 125), first information associated with a procedure, where the procedure includes a control representing a security policy (202). In some embodiments, the first information may include information formatted in accordance with JSON. Further, in some embodiments, the security policy may include access restrictions associated with one or more users.

The method 200 may include transforming the first information into first transformed information (204). In some embodiments, transforming the first information into the first transformed information may include at least one of standardizing, normalizing, or reformatting the first information.

The method 200 may include determining, using a first machine learning model (e.g., the first machine learning model 113), a first plurality of features including a first average reconciliation ratio and a first indication of whether the security policy is accurate, based on the first transformed information, where the first machine learning model was trained using data representing the procedure, a plurality of criteria associated with the control, and historical audit data (206). In some aspects, the first average reconciliation ratio may represent a number of items associated with the first transformed information and reconciled during a time period, divided by a total number of items that are associated with the first transformed information and that should have been reconciled during the time period. In some embodiments, the first plurality of features may include one or more of the following: an indication of whether the first transformed information complies with the security policy, an indication of whether the first transformed information includes sensitive information, a determination of whether the first transformed information satisfies a value representing a threshold amount of evidence, a determination of whether the first transformed information satisfies a value representing the threshold number of samples, or a determination of whether the first transformed information satisfies a maximum error rate. Further, in some embodiments, the plurality of criteria may include one or more of the following: a value representing a threshold amount of evidence, a value representing a threshold number of samples, or a maximum error rate.

The method 200 may include determining, using a second machine learning model (e.g., the second machine learning model 114), a first probability that the first transformed information does not satisfy the plurality of criteria, based on the first plurality of features, where the second machine learning model was trained using at least the historical audit data (208). In some embodiments, the first probability may represent a likelihood that the control representing the security policy will fail a formal audit (e.g., that is identical or similar to an audit defined in an audit plan). In some other embodiments, the first probability may represent a score that reflects whether the control representing the security policy fails an audit defined in an audit plan. The method 200 may also include determining whether the first probability is greater than a threshold value (210). The method 200 may include, upon determining that the first probability is greater than the threshold value, determining, using a third machine learning model (e.g., the third machine learning model 115), a recommendation to implement one or more actions associated with the control, based on the first probability, where the third machine learning model was trained using at least the data representing the procedure and the plurality of criteria associated with the control (212).

In some embodiments, the method 200 may further include transmitting, to the external entity, the recommendation to implement the one or more actions associated with the control. The method 200 may include receiving, from the external entity, second information associated with each of the recommendation and an updated version of the control. The method 200 may include transforming the second information into second transformed information. The method 200 may include determining, using the first machine learning model, a second plurality of features including a second average reconciliation ratio and a second indication of whether the security policy is accurate, based on the second transformed information. The method 200 may include determining, using the second machine learning model, a second probability that the second information does not satisfy the plurality of criteria, based on the second plurality of features. In some embodiments, the second probability may represent a likelihood that an updated version of the control representing the security policy (e.g., where the control has been updated in accordance with the recommendation) will fail the formal audit. In some other embodiments, the second probability may represent a score that reflects whether the updated version of the control representing the security policy fails the audit defined in the audit plan. The method 200 may include determining that the second probability is less than or equal to the threshold value. In some embodiments, where the second probability is determined to be less than or equal to the threshold value, the second probability may represent that the second information (or the control) satisfies the plurality of criteria.

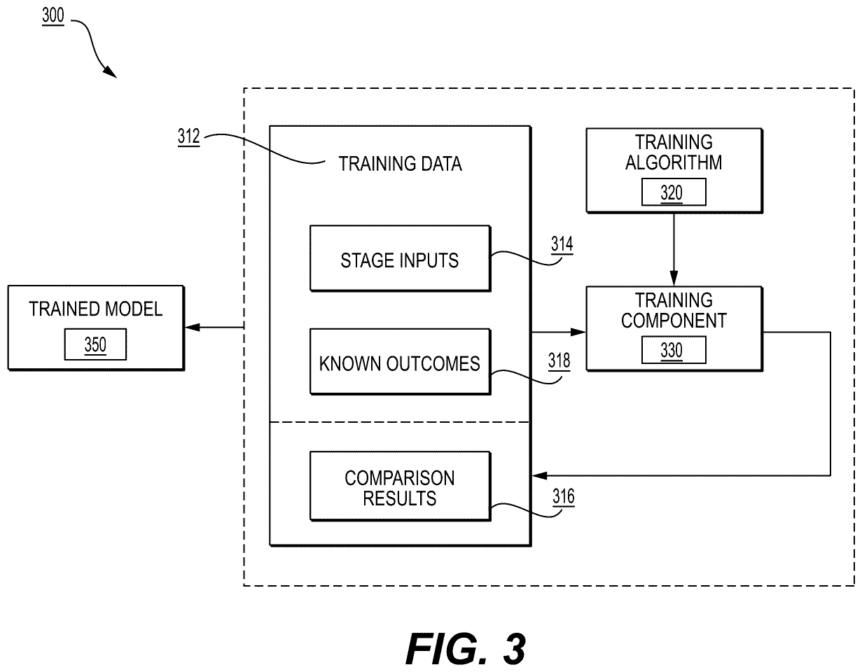

As disclosed herein, one or more implementations may be applied by using one or more machine learning models (e.g., the first machine learning model 113, the second machine learning model 114, the third machine learning model 115, etc.). A machine learning model as disclosed herein may be trained using one or more components of FIG. 1. As shown in flow diagram 300 of FIG. 3, training data 312 may include one or more of stage inputs 314 and known outcomes 318 related to a machine learning model to be trained. The stage inputs 314 may be from any applicable source including a component shown in FIG. 1 provided herein. In some embodiments, the stage inputs 314 may represent input data received by a computing device (e.g., from a mouse, keyboard, or storage associated with the computing device, or from another computing device). The known outcomes 318 may be included for machine learning models generated based on supervised or semi-supervised training. In some embodiments, the known outcomes 318 may represent determinations regarding the identities of users or entities associated with the stage inputs 314 (or determinations regarding whether the stage inputs 314 represent expected input data or unexpected input data). An unsupervised machine learning model might not be trained using known outcomes 318. Known outcomes 318 may include known or desired outputs for future inputs similar to or in the same category as stage inputs 314 that do not have corresponding known outputs.

The training data 312 and a training algorithm 320 may be provided to a training component 330 that may apply the training data 312 to the training algorithm 320 to generate a trained machine learning model 350 (e.g., the first machine learning model 113, the second machine learning model 114, or the third machine learning model 115). According to an implementation, the training component 330 may be provided comparison results 316 that compare a previous output of the corresponding machine learning model to apply the previous result to re-train the machine learning model. The comparison results 316 may be used by the training component 330 to update the corresponding machine learning model. The training algorithm 320 may utilize machine learning networks or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, or discriminative models such as Decision Forests and maximum margin methods, or the like. The output of the flowchart 300 may be a trained machine learning model 350.

A machine learning model disclosed herein may be trained by adjusting one or more weights, layers, or biases during a training phase. During the training phase, historical or simulated data may be provided as inputs to the model. The model may adjust one or more of its weights, layers, or biases based on such historical or simulated information. The adjusted weights, layers, or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

In general, any process or operation discussed in this disclosure that is understood to be computer-implementable, such as the process (or method) illustrated in FIG. 2, may be performed by one or more processors of a computer system. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

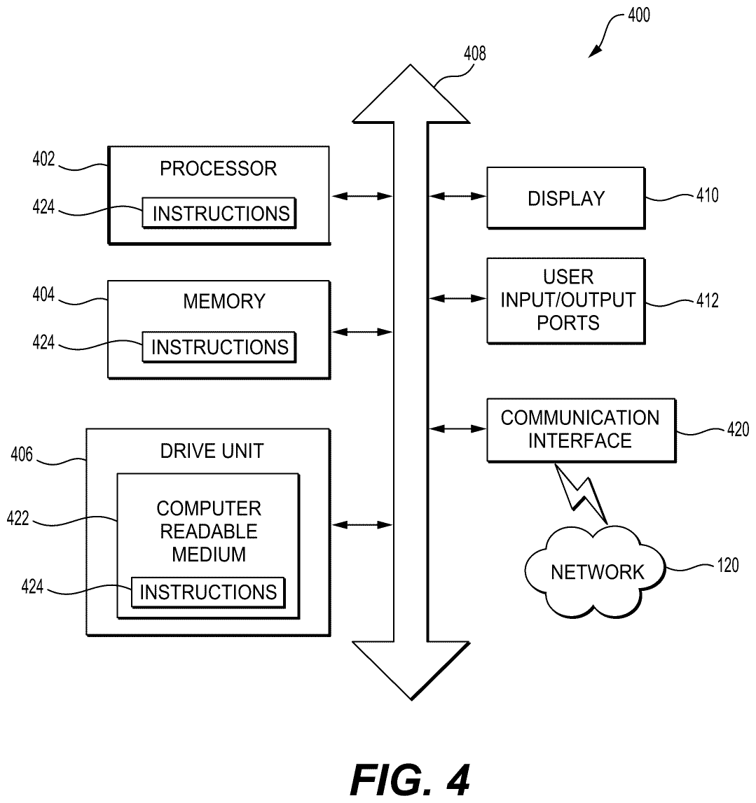

FIG. 4 is a simplified functional block diagram of a computer 400 that may be configured as a device for executing the method 200 of FIG. 2, according to exemplary embodiments of the present disclosure. For example, in some embodiments, the computer 400 may be configured as the computing device 105, according to exemplary embodiments of this disclosure. In some other embodiments, the computer 400 may be configured as the first external entity system 125, according to exemplary embodiments of this disclosure. In some other embodiments, the computer 400 may be configured as the second external entity system 130, according to exemplary embodiments of this disclosure. In some other embodiments, the computer 400 may be configured as the API system 135, according to exemplary embodiments of this disclosure. In various embodiments, any of the devices or systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage (or drive) unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display (or display screen) 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, from an external entity, first information associated with a procedure, wherein the procedure includes a control representing a security policy;
transforming the first information into first transformed information;
determining, using a first machine learning model, a first plurality of features including a first average reconciliation ratio and a first indication of whether the security policy is accurate, based on the first transformed information, wherein the first machine learning model was trained using data representing the procedure, a plurality of criteria associated with the control, and historical audit data;
determining, using a second machine learning model, a first probability that the first transformed information does not satisfy the plurality of criteria, based on the first plurality of features, wherein the second machine learning model was trained using at least the historical audit data;
determining whether the first probability is greater than a threshold value; and
upon determining that the first probability is greater than the threshold value, determining, using a third machine learning model, a recommendation to implement one or more actions associated with the control, based on the first probability, wherein the third machine learning model was trained using at least the data representing the procedure and the plurality of criteria associated with the control.

2. The method of claim 1, wherein the security policy includes access restrictions associated with one or more users, and wherein the first plurality of features further includes an indication of whether the first transformed information complies with the security policy.

3. The method of claim 1, wherein the first plurality of features further includes an indication of whether the first transformed information includes sensitive information.

4. The method of claim 1, wherein the first information includes information formatted in accordance with JavaScript Object Notation (JSON).

5. The method of claim 1, wherein the first average reconciliation ratio represents a number of items associated with the first transformed information and reconciled during a time period, divided by a total number of items that are associated with the first transformed information and that should have been reconciled during the time period.

6. The method of claim 1, wherein the plurality of criteria includes a value representing a threshold amount of evidence, and wherein the first plurality of features further includes a determination of whether the first transformed information satisfies the value representing the threshold amount of evidence.

7. The method of claim 1, wherein the plurality of criteria includes a value representing a threshold number of samples, and wherein the first plurality of features further includes a determination of whether the first transformed information satisfies the value representing the threshold number of samples.

8. The method of claim 1, wherein the plurality of criteria includes a maximum error rate, and wherein the first plurality of features further includes a determination of whether the first transformed information satisfies the maximum error rate.

9. The method of claim 1, wherein transforming the first information into the first transformed information includes at least standardizing the first information.

10. The method of claim 1, further comprising,
transmitting, to the external entity, the recommendation to implement the one or more actions associated with the control;
receiving, from the external entity, second information associated with each of the procedure, the recommendation, and an updated version of the control;
transforming the second information into second transformed information;
determining, using the first machine learning model, a second plurality of features including a second average reconciliation ratio and a second indication of whether the security policy is accurate, based on the second transformed information;
determining, using the second machine learning model, a second probability that the second information does not satisfy the plurality of criteria, based on the second plurality of features; and
determining that the second probability is less than or equal to the threshold value.

11. A system comprising:
at least one processor; and
at least one memory having programming instructions stored thereon, which, when executed by the at least one processor, cause the system to perform operations comprising:
receiving, from an external entity, information associated with a procedure, wherein the procedure includes a control representing a security policy;
transforming the information into transformed information;
determining, using a first machine learning model, a plurality of features including an average reconciliation ratio, based on the transformed information, wherein the first machine learning model was trained using at least data representing the procedure and a plurality of criteria associated with the control;
determining, using a second machine learning model, a probability that the transformed information does not satisfy the plurality of criteria, based on the plurality of features, wherein the second machine learning model was trained using at least historical audit data;
determining, using a third machine learning model, a recommendation to implement one or more actions associated with the control, based on the probability, wherein the third machine learning model was trained using at least the data representing the procedure and the plurality of criteria associated with the control.

12. The system of claim 11, wherein the operations further comprise:
determining whether the probability is greater than a threshold value, wherein the recommendation to implement one or more actions associated with the control is determined responsive to determining that the probability is greater than the threshold value.

13. The system of claim 11, wherein the security policy includes access restrictions associated with one or more users, and wherein the plurality of features further includes an indication of whether the transformed information complies with the security policy.

14. The system of claim 11, wherein the plurality of features further includes an indication of whether the transformed information includes sensitive information.

15. The system of claim 11, wherein the information includes information formatted in accordance with JavaScript Object Notation (JSON).

16. The system of claim 11, wherein the average reconciliation ratio represents a number of items associated with the transformed information and reconciled during a time period, divided by a total number of items that are associated with the transformed information and that should have been reconciled during the time period.

17. The system of claim 11, wherein the plurality of criteria includes a value representing a threshold amount of evidence, and wherein the plurality of features further includes a determination of whether the transformed information satisfies the value representing the threshold amount of evidence.

18. The system of claim 11, wherein the plurality of criteria includes a value representing a threshold number of samples, and wherein the plurality of features further includes a determination of whether the transformed information satisfies the value representing the threshold number of samples.

19. The system of claim 11, wherein the plurality of criteria includes a maximum error rate, and wherein the plurality of features further includes a determination of whether the transformed information satisfies the maximum error rate.

20. A method comprising:
receiving, from an external entity, information associated with a procedure, wherein the procedure includes a control representing a security policy;
transforming the information into transformed information;
determining, using a first machine learning model, a plurality of features including an average reconciliation ratio and an indication of whether the security policy is accurate, based on the transformed information, wherein the first machine learning model was trained using at least data representing the procedure and a plurality of criteria associated with the control;
determining, using a second machine learning model, a probability that the transformed information does not satisfy the plurality of criteria, based on the plurality of features, wherein the second machine learning model was trained using at least historical audit data;
determining whether the probability is greater than a threshold value; and
upon determining that the probability is greater than the threshold value, determining, using a third machine learning model, a recommendation to implement one or more actions associated with the control, based on the probability, wherein the third machine learning model was trained using at least the data representing the procedure and the plurality of criteria associated with the control.
